(19) United States
(12) Patent Application Publication
(10) Pub. No.: US 2025/0244350 A1
(43) Pub. Date: Jul. 31, 2025

(54) AUTOMATION TRACK CONFIGURATIONS FOR MITIGATING SPILLS AND CONTAMINATION

(71) Applicant: Siemens Healthcare Diagnostics Inc., Tarrytown, NY (US)

(72) Inventor: Narayanan Ramakrishnan, New City, NY (US)

(73) Assignee: Siemens Healthcare Diagnostics Inc., Tarrytown, NY (US)

(21) Appl. No.: 18/848,477

(22) PCT Filed: Mar. 21, 2023
(86) PCT No.: PCT/US2023/064742

§ 371 Date: Sep. 18, 2024

Related U.S. Application Data
(60) Provisional application No. 63/269,692, filed on Mar. 21, 2022.

(51) Int. Cl. G01N 35/04

(52) U.S. Cl. CPC G01N 35/04; G01N 2035/0477; G01N 2035/0496

(57) ABSTRACT

Systems and methods for passively redirecting liquid contaminants from the active region of riding surfaces of track systems for liquid handler systems, including surface energy gradient, channels, and roughness gradients. The described techniques redirect liquids in a passive manner, without requiring any additional electromechanical components or active control systems that would draw additional power and require additional layers of control architecture to manage.

### CROSS REFERENCE TO RELATED APPLICATION

This application claims the benefit of U.S. Provisional Patent Application No. 63/269,692, entitled “AUTOMATION TRACK CONFIGURATIONS FOR MITIGATING SPILLS AND CONTAMINATION” filed Mar. 21, 2022, the disclosure of which is hereby incorporated by reference in its entirety for all purposes.

### BACKGROUND

Liquid handlers are robotic systems that are designed to dispense and process selected quantities of reagents, samples, or other liquids. Some liquid handlers are additionally adapted to analyze samples using, for example, immunoassay and/or clinical chemistry techniques. Such types of liquid handlers could be referred to as “analyzers” or “analyzer systems.” Some liquid handlers can include a number of modules (also referred to as stations) and a transport system to move samples between the various modules. It is highly desirable for the liquid handler transport systems to move the sample containers in a smooth manner, avoid causing the sample containers to collide with each other and, otherwise prevent liquids from spilling from their containers during transport. In particular, liquid spills waste reagents and/or samples (which could potentially impact the integrity of any tests being performed) and if the spill occurs on the track can also create obstructions that could negatively impair the movement of subsequent sample containers.

Liquid handlers are often used in in vitro diagnostics (IVD) applications. IVD allows labs to assist in the diagnosis of disease based on assays performed on patient fluid samples. IVD includes various types of analytical tests and assays related to patient diagnosis and therapy that can be performed by analysis of a liquid sample taken from a patient's bodily fluids, or abscesses. These assays are typically conducted with automated clinical chemistry analyzers onto which fluid containers, such as tubes or vials, containing patient samples have been loaded. The analyzer extracts a liquid sample from the vial and combines the sample with various reagents in special reaction cuvettes or tubes (referred to, generally, as reaction vessels). In some conventional systems, a modular approach is used for analyzers. A lab automation system can shuttle samples between one sample processing module (module) and another module. Modules may include one or more stations, including sample handling stations and analyzer modules/testing stations (e.g., a unit that can specialize in certain types of assays), or can otherwise provide testing services to the larger analyzer, which may include immunoassay (IA) and clinical chemistry (CC) stations. Some traditional IVD automation track systems comprise systems that are designed to transport samples from one fully independent module to another standalone module. This allows different types of tests to be specialized in two different stations/modules or allows two redundant stations to be linked to increase the volume of sample throughput available. These lab automation systems, however, are often bottlenecks in multi-station analyzers. Relatively speaking, traditional lab automation systems lack large degrees of intelligence or autonomy to allow samples to independently move between stations.

Conventional IVD analyzers use friction-based track systems, conveyor belt systems, or magnetic drive systems for transporting samples between the various modules of the analyzers. However, these conventional sample transport systems have several issues. For example, friction-based track or conveyor belt systems typically shuttle individual carrier mechanisms, sometimes called pucks, or racks of containers, between different stations. Samples may be stored in sample containers, such as test tubes that are placed into a puck by an operator or robot arm, for transport between stations in an analyzer along the track. These transport systems, however, can only move in one direction at a time, and any samples on the track will move in the same direction at the same speed. When a sample needs to exit the friction track, gating/switching can be used to move individual pucks into offshoot paths. A drawback with this set up is that singulation must be used to control the direction of any given puck at each gate and switch. Further, friction-based track or conveyor belt systems are also typically slow-moving. Because all samples in pucks move together, these pucks routinely crash into one another and the track moves at the same speed around curves and straightaways. Moreover, stopping, singulating, and switching occur by a puck impacting a stationary object, such as a diversion arm or stopping point. As a result, friction tracks typically move at a relatively low velocity to prevent fluids contained in the open fluid sample containers in the pucks from splashing and spilling onto laboratory equipment or the automation track. For large laboratory systems, it may take several minutes for a friction track to transport one sample puck from one end of the room to another end of the room. This adds to overall latency, and can increase traffic due to increased travel times, which can reduce the turnaround time or average throughput of samples in a batch inserted into an analyzer and the automation system. Therefore, conventional friction-based track systems or conveyor belt systems are generally not desirable for application in liquid handlers.

Conventional magnetically driven transport systems also face their own issues. In particular, sample transport automation systems that drive vessel movers along a riding surface have to contend with contamination of the riding surface by samples from tubes carried by the vessel movers, as well as from other mechanisms and modules interfacing the Automation track system. Contaminants could include, for example, viscous and sticky fluids (e.g., blood serum). When dried, these fluids can form crusty films that can alter the tribological characteristics of the riding surface significantly. This in turn can be detrimental to the smooth and predictable motion of the vessel movers along the track segments. This problem is more acute with liquid handler and automation systems that make use of smaller vessel movers because they have reduced thrust capability and reduced inertia. The stick-slip and abnormal frictional characteristics induced by such contamination of the riding surface can severely impede smooth motion control of the vessel movers, which is necessary for reliable and robust transport of sample fluids between various modules and dispense locations on the sample transport automation track system. Similarly, interaction of the vessel movers with sufficiently large drops or blobs of liquid contaminant on the surface can cause a disturbance to the puck motion that may be detrimental to control stability of the puck motion as well as result in splashing under certain conditions.

To address these and other issues, magnetically driven transport system that use a printed circuit board (PCB)-based substrate for the automation track have been proposed. A PCB-based automation track substrates solves several issues with conventional liquid handler transport systems, including the cost (because PCBs are less expensive than conventional metallic track system substrates) and weight (because PCBs are lighter than conventional metallic track system substrates) of the liquid handler systems. However, using PCBs as the track system substrate introduces new issues that are not present in conventional liquid handler transport systems. Very systems and techniques for addressing these unique problems specific to PCB-based transport systems are described herein. Although often described in the context of the PCB-based substrate track system, the techniques described herein could likewise apply to non-PCB track systems, including track systems having metallic riding surfaces. In particular, the surface modification concepts disclosed herein could be applied to other conventional track riding surfaces as well. However, the concepts described herein are described in the context of track systems having riding surfaces on which the vessel movers slide or roll and should be distinguished from track systems where the vessel movers do not slide or roll (e.g., conveyor belts or ski chair-lift type conveyors).

### SUMMARY

The present disclosure generally relates to laboratory automation systems and clinical chemistry analyzer systems for use in a laboratory environment. In particular, the present disclosure is generally directed to track configurations for analyzer systems that are configured to remove or mitigate the effects of liquid contaminants on the track.

In one embodiment, the present disclosure is directed to a track system for a liquid handler system, the track system configured to transport a vessel mover, the vessel mover comprising a magnet, the track system comprising: a track segment comprising a substrate, the substrate comprising a surface configured to support the vessel mover thereon; a coil array associated with the track segment, the coil array configured to interact with the magnet to define a linear electromagnetic actuator and propel the vessel mover along the track segment; a first region on the surface, the first region comprising a first surface energy; and a second region on the surface, the second region comprising a second surface energy; wherein: the first surface energy is less than the second surface energy, the first region and the second region are non-overlapping, and the first region and the second region define a surface energy gradient that is configured to cause a liquid on the surface to flow towards a lateral edge of the surface.

In some embodiments of the track system, the first region comprises a hydrophobic coating and the second region comprises an uncoated surface of the PCB substrate.

In some embodiments of the track system, the first region comprises a hydrophobic coating and the second region comprises a hydrophilic coating.

In some embodiments of the track system, the substrate comprises a printed circuit board (PCB) substrate.

In some embodiments of the track system, the track system further comprises a third region on the surface, the third region comprising a third surface energy; wherein: the third surface energy is less than the second surface energy and more than the first surface energy, the third region does not overlap with the first region or the second region, and the first region, the second region, and the third region define the surface energy gradient that is configured to cause a liquid on the surface to flow towards a lateral edge of the surface.

In some embodiments of the track system, the second region is arranged along the lateral edge of the surface.

In some embodiments of the track system, the second region defines a plurality of pathways extending through the first region, the plurality of pathways configured to direct the liquid to the lateral edge of the surface.

In one embodiment, the present disclosure is directed to a liquid handler system for analyzing a sample contained with a vessel, the liquid handle system comprising: a vessel mover configured to receive the vessel, the vessel mover comprising a magnet; and a track system configured to transport the vessel mover, the track system comprising: a track segment comprising a substrate, the substrate comprising a surface configured to support the vessel mover thereon, a coil array associated with the track segment, the coil array configured to interact with the magnet to define a linear electromagnetic actuator and propel the vessel mover along the track segment, a first region on the surface, the first region comprising a first surface energy, and a second region on the surface, the second region comprising a second surface energy, wherein: the first surface energy is less than the second surface energy, the first region and the second region are non-overlapping, and the first region and the second region define a surface energy gradient that is configured to cause a liquid on the surface to flow towards a lateral edge of the surface.

In some embodiments of the liquid handler system, the first region comprises a hydrophobic coating and the second region comprises an uncoated surface of the substrate.

In some embodiments of the liquid handler system, the first region comprises a hydrophobic coating and the second region comprises a hydrophilic coating.

In some embodiments of the liquid handler system, the substrate comprises a printed circuit board (PCB) substrate.

In some embodiments of the liquid handler system, the track system further comprises: a third region on the surface, the third region comprising a third surface energy; wherein: the third surface energy is less than the second surface energy and more than the first surface energy, the third region does not overlap with the first region or the second region, and the first region, the second region, and the third region define the surface energy gradient that is configured to cause a liquid on the surface to flow towards a lateral edge of the surface.

In some embodiments of the liquid handler system, the second region is arranged along the lateral edge of the surface.

In one embodiment, the present disclosure is directed to a track system for a liquid handler system, the track system configured to transport a vessel mover, the vessel mover comprising a magnet, the track system comprising: a track segment comprising a substrate, the substrate comprising a surface configured to support the vessel mover thereon; a coil array associated with the track segment, the coil array configured to interact with the magnet to define a linear electromagnetic actuator and propel the vessel mover along the track segment; a first region on the surface, the first region comprising a first roughness; and a second region on the surface, the second region comprising a second roughness; wherein: the first roughness is less than the second roughness, the first region and the second region are non-overlapping, and the first region and the second region define a surface roughness gradient that is configured to cause a liquid on the surface to flow towards a lateral edge of the surface.

In some embodiments of the track system, the second region is formed via a surface modification process selected from the group consisting of a plasma treatment, exposure to an acidic solution with masking, or exposure to a basic solution with masking.

In some embodiments of the track system, the track system further comprises: a third region on the surface, the third region comprising a third roughness; wherein: the third roughness is less than the second roughness and more than the first roughness, the third region does not overlap with the first region or the second region, and the first region, the second region, and the third region define the surface roughness gradient that is configured to cause a liquid on the surface to flow towards a lateral edge of the surface.

In some embodiments of the track system, the second region is arranged along the lateral edge of the surface.

In some embodiments of the track system, the substrate comprises a printed circuit board (PCB) substrate.

In one embodiment, the present disclosure is directed to a track system for a liquid handler system, the track system configured to transport a vessel mover, the vessel mover comprising a magnet, the track system comprising: a track segment comprising a substrate, the substrate comprising a surface configured to support the vessel mover thereon; a coil array associated with the track segment, the coil array configured to interact with the magnet to define a linear electromagnetic actuator and propel the vessel mover along the track segment; and a plurality of channels extending along the surface, the plurality of channels configured to cause a liquid on the surface to flow towards a lateral edge of the surface via capillary action.

In some embodiments of the track system, one or more of the plurality of channels comprises at least one of a surface energy gradient or a surface roughness gradient induce the flow of the liquid therethrough.

In some embodiments of the track system, a cross-section of the plurality of channels tapers from a centerline of the surface to the lateral edge.

In some embodiments of the track system, the track system further comprises a low surface energy coating disposed proximal to a centerline of the surface, wherein a portion of the plurality of channels comprises an increased hydrophobicity to define a surface energy gradient with the low surface energy coating.

In some embodiments of the track system, the substrate comprises a printed circuit board (PCB) substrate.

### FIGURES

The accompanying drawings, which are incorporated in and form a part of the specification, illustrate the embodiments of the invention and together with the written description serve to explain the principles, characteristics, and features of the invention. In the drawings:

FIG. 1 is a top down view of an exemplary sample handling module, in accordance with at least one aspect of the present disclosure.

FIG. 2 is a perspective view of an exemplary sample handling module in accordance with at least one aspect of the present disclosure.

FIG. 3 is a diagrammatic view of an exemplary integral, modular automation track system, in accordance with at least one aspect of the present disclosure.

FIG. 4 is a perspective view of an exemplary automation track system, in accordance with at least one aspect of the present disclosure.

FIG. 5 is a perspective view of an exemplary automation track system, in accordance with at least one aspect of the present disclosure.

FIG. 6 is a cross sectional view of an exemplary automation track system, in accordance with at least one aspect of the present disclosure.

FIG. 7 is a top down view of an exemplary automation track system, in accordance with at least one aspect of the present disclosure.

FIG. 8 is a diagram of a track segment of a liquid handler system, in accordance with at least one aspect of the present disclosure.

FIG. 9 is a diagram of a vessel mover actuator, in accordance with at least one aspect of the present disclosure.

FIG. 10 is a diagram of a first embodiment of a track segment configured to mitigate liquid contaminants.

FIG. 11 is a diagram of a second embodiment of a track segment configured to mitigate liquid contaminants.

FIG. 12 is a diagram of a third embodiment of a track segment configured to mitigate liquid contaminants.

FIG. 13 is a diagram of a fourth embodiment of a track segment configured to mitigate liquid contaminants.

FIG. 14 is a diagram of a fifth embodiment of a track segment configured to mitigate liquid contaminants.

FIG. 15 is a diagram of a sixth embodiment of a track segment configured to mitigate liquid contaminants.

### DESCRIPTION

This disclosure is not limited to the particular systems, devices and methods described, as these may vary. The terminology used in the description is for the purpose of describing the particular versions or embodiments only, and is not intended to limit the scope.

### Automated Liquid Handler Systems

A liquid handler or liquid handling robot a system that is designed to dispense and process any type of liquid, including reagents and patient samples. Liquid handles are particularly adapted to automate workflows in life science laboratories, such as clinical laboratories or research laboratories. Some liquid handlers, which can be referred to as “analyzers” or “analyzer systems” are additionally adapted to process and perform tests on samples using, for example, immunoassay and/or clinical chemistry techniques.

Liquid handlers can include automation systems, either integrally or as modules coupled to the liquid handlers. Some liquid handler systems can include a number of modules or stations that are adapted to perform different tasks or tests. In these embodiments, the automation systems can include a transport system that is adapted to transport containers of samples and/or reagents between the various modules or stations. As noted above, transport systems can include friction-based movement systems, conveyor belts, and magnetically driven movement systems. Automation systems can further include sensor assemblies for detecting parameters associated with the containers or other aspects of the transport systems and control systems that are configured to control the movement of the containers accordingly.

In some embodiments, liquid handler systems can utilize a modular system including an automated clinical chemistry analyzer module and an automated immunoassay analyzer module, with sample loading capability to transport patient samples to and from analyzer module(s) where in vitro diagnostic assay analyses are performed. The system can be scalable in multiple configurations of the modules allowing customer yearly throughput needs ranging from low volume to very high volume/mega market segments (i.e., 500,000 to 5M or more tests per year).

In some embodiments, the automation system can be described as a process control manager (PCM) that manages the processing of samples. This includes providing input and output for samples into and out of the system, temporary storage of samples while awaiting processing, scheduling of samples for processing at various analyzers attached to the PCM, facilitation of the movement of samples throughout an automation track (including onto and off of the automation track), and, in some embodiments, maintenance of the automation systems. In various embodiments, a PCM can include a variety of different modules, including a sampler handler and a vessel mover.

The sample handler provides a means for the user to load and unload regular samples, STAT samples, and control/calibrator vials onto and off of the system. Within the sample handler, the robot subsystem is responsible for moving these tubes between other subsystems and modules, including the sample I/O (drawer trays), control storage, and the vessel mover.

The vessel mover subsystem handles this material distribution. Under normal conditions, a lab technician never operates the vessel mover track directly. The vessel mover manages carriers on an automation track that moves samples or reagents, each carrier having a dedicated type of holders. In some embodiments, liquid handler systems can include reagent carriers that are configured to accept a reagent cartridge and to transport the reagent cartridge, via the automation track, to a location accessible to the one or more analyzer modules. In some embodiments, a reagent carrier can be adapted to handle reagents from both an immunoassay module and clinical chemistry module.

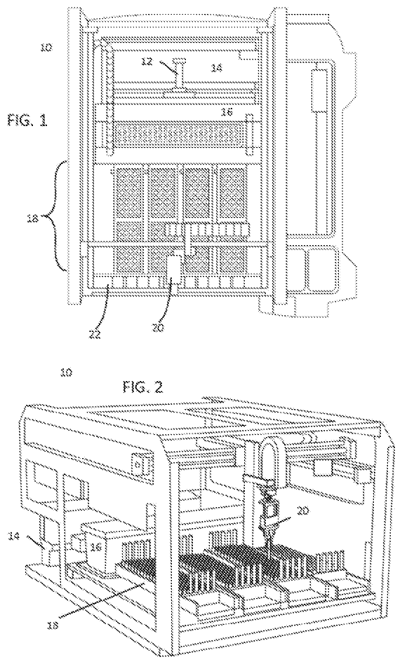

FIG. 1 shows a top down view of an exemplary sample handler 10 that may be used for some embodiments. Within this figure, sample handler 10 is oriented so that the front (i.e., the face that the operator interacts with) is at the bottom of the page, while the back of the automation track is located at the top of the page. Sample handler 10 includes a tube characterization station 12 at the robot/track interface. Tube characterization station 12 characterizes tubes and carriers when tubes are placed on carriers on track 14. This allows information to be ascertained about the identity of the tube placed in each carrier, and the physical condition of each tube (e.g., size of the tube, fluid level, whether there is a tube top cup, etc.) Adjacent to the tube characterization station 12 sits a control/calibrator storage region 14. This allows long-term refrigerated storage of control and calibrator fluids near the track, allowing these fluids to be easily placed into carriers on the track for movement to relevant locations in the analyzer. The location of storage 16 also allows input/output drawers 18 to be placed in the front of sample handler 10. In this example, there are four adjacent drawers 18 that can be individually opened and pulled out.

A robot arm 20 can move in two dimensions to pick up any of the tubes in drawers 18 and move those tubes to and from storage 16 and carriers on track 14. Robot arm 20 can be positioned by moving a gantry from the front to the back of a sample handler 10 while a carriage moves side to side along that gantry. Opposable end effectors can then be moved vertically to reach down to pick up tubes, closing the end effectors when they are properly positioned to engage the tube.

To assist the robot arm 20 in successfully engaging each tube, a drawer vision system 22 is placed above the drawers at the opening to the drawers. This allows a series of images to be taken, looking down at the tubes in the trays, as the trays are moved past the drawer vision system. By strobing a series of cameras, multiple images can be captured in a buffer, where each tube appears in multiple images. These images can then be analyzed to determine the physical characteristics of each tube. For example, diameters and heights of each tube can be determined. Similarly, the capped or uncapped states of each sample can be quickly determined. Furthermore, the presence or absence of a tube top cup (a small plastic well that is placed on top of a tube to allow a tube to transport a much smaller volume with greater depth of the sample, to allow aspiration to more easily take place) can be ascertained. Similarly, the characteristics of any cap can be ascertained by the images. This can include certain color markings on the cap to identify a given sample as a higher priority (STAT) sample.

The module manager PC can utilize this information to schedule samples to be moved from each tray in drawers 18 into carriers on track 14. The module manager PC can also instruct robot arm 20 how to interact with each tube, including identifying the proper height for the end effectors before engagement, and the proper force or distance to use when engaging the end effectors to accommodate multiple diameters of tubes.

FIG. 2 is a perspective view of a sample handler 10. In this example, track 14 is roughly parallel with the front face of drawers 18, while refrigerated storage 16 is a large physical object between drawers 18 and track 14. Meanwhile, robot arm 20 is moved on supports, well above the height of drawers 18 and refrigerated storage 16. In some embodiments, the sample handler 10 can include a tube characterization station 12 and a drawer vision system 22; however, these stations are omitted from the view in FIG. 2 in order to allow the internals of sample handler 10 to be better understood.

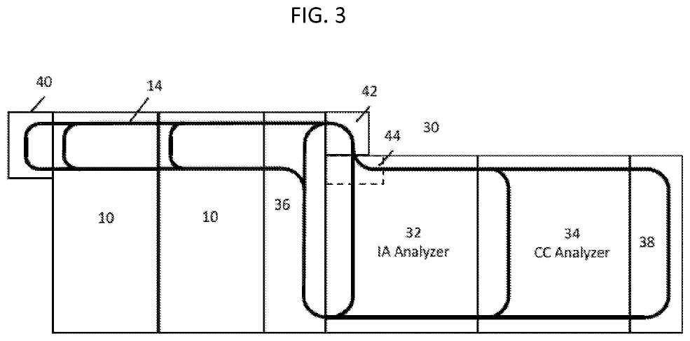

FIG. 3 illustrates the vessel mover components of the PCM that moves samples from an input region to analyzer modules, assists in handling those samples within the analyzer, and returns process samples to the output region of the sample handler. Multi module analyzer system 30 includes multiple interconnected modules. In this example, system 30 includes multiple sample handlers 10. By utilizing multiple sample handlers, more sample trays can be placed into the system, allowing a larger batch to be started at the beginning of the shift. Furthermore, this allows twice as many samples to be placed onto, and taken off of, the track. This means that, for larger systems with multiple analyzer modules that can operate in parallel, input/output throughput can match the analysis throughput of the parallel analyzers. For example, if an analyzer module can handle 500 samples per hour, and three analyzer modules are used, the input/output demand for feeding these modules may be up to 1500 samples per hour. In some embodiments, a single sample handler may not be able to handle this demand, necessitating adding multiple sample handlers to keep up with the input/output demand of the analyzer modules.

Furthermore, in some embodiments, one of the sample handlers can be set up to be used as an input, while the other sample handler can be set up as an output. By using a modular approach, a single sample handler 10 can be used but, for larger systems, two or more sample handlers can be used.

In an exemplary system 30, two analyzer modules are utilized. Analyzer module 32 is an immunoassay (IA) analyzer. Analyzer module 34 is a clinical chemistry (CC) analyzer. These two analyzer modules perform different assays, testing for different characteristics of patient samples.

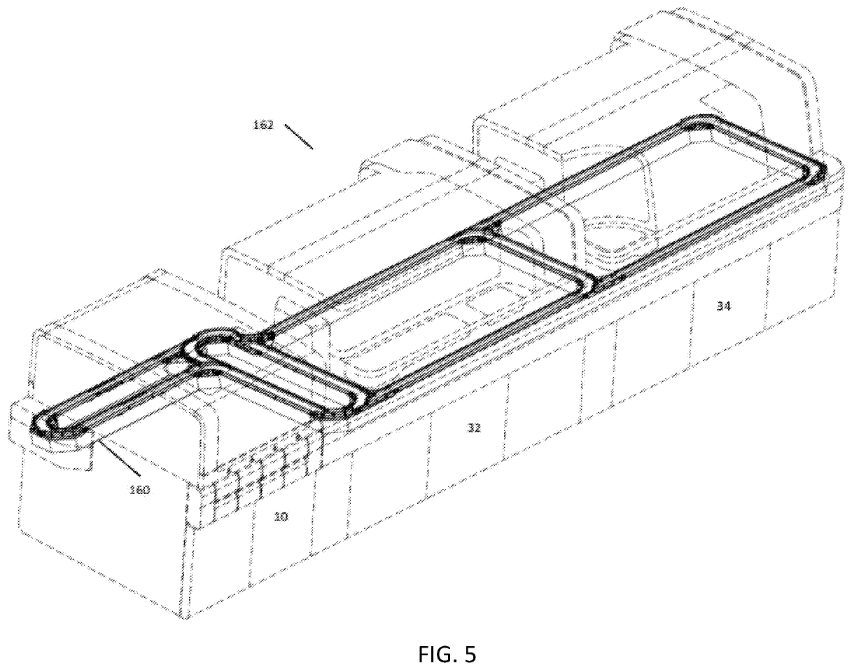

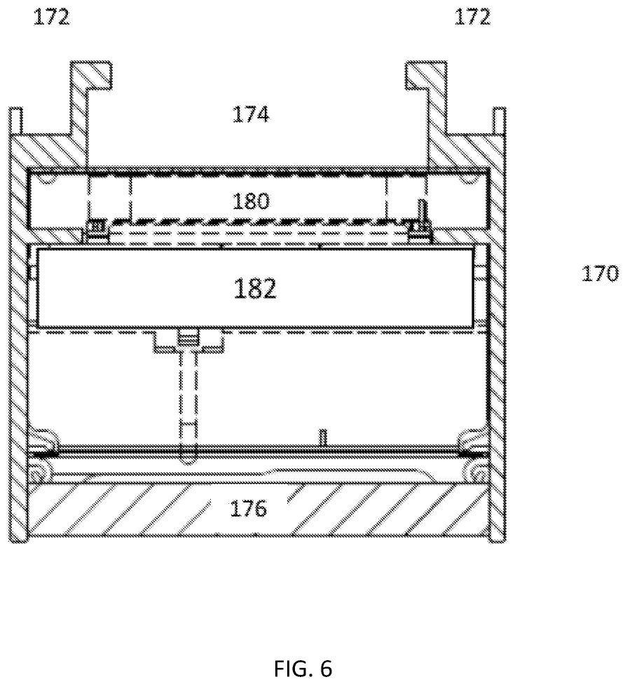

Track 14 is a multi-branching track that forms the heart of the vessel mover system. As can be seen, track 14 comprises branches and lengths that are provided integral to sample handlers 10 and analyzer modules of 32 and 34. The functions of the individual branches will be explained with respect to FIGS. 5 and 6. In addition to the track segments provided by these modules, additional modules 38, 40, and 42 provide short dedicated track sections that may be bolted to the track portions provided by the other modules. Track modules 36, 38, 40, and 42 provide powered track segments, without additional hardware related to sample handler modules or analyzer modules. Whereas modules 10, 32, and 34 may be full cabinets extending from a laboratory floor to the height of track 14, and above, track segment modules 36, 38, 40, and 42 may be bolt-on segments that extend from the cabinets of the other modules, without requiring floor-length support. Each of the modules in FIG. 3 can be bolted together in modular fashion, utilizing leveling hardware, such that each track segment between adjacent modules forms a virtually seamless track for carriers to traverse the vessel mover system.

In exemplary system 30, it can be seen that section 44 of the track of analyzer module 32 may need to be altered from the corresponding section of analyzer module 34. In some embodiments, the track segments of analyzer modules are in the same configuration as that shown in analyzer module 34 when they are shipped from the factory. This allows multiple analyzers to be placed in series, simply bolting their respective track segments together to form a long chain. In some embodiments, where there is an offset between the back track segment of the sample handler modules and the analyzer modules, as is illustrated in system 30, an S-shaped bend may be needed to allow carriers to move from the back track section of analyzer modules to the back track section of the sample handler modules. In this example, this S-shaped bend is provided by bolting on track section 42 and the altered track segment in area 44. Thus, it should be understood that the track segments within analyzer modules, while integral to those modules, can be extensively modified at the time of installation, allowing multiple configurations of the track segments within an analyzer module. However, it should be understood that these track segments are still very much integral to those analyzer modules. In some embodiments, the back of analyzer modules 32 and 34 are flush with the backs of sample handlers 10, eliminating the need for altering track segment 44 and section 42, entirely.

Track segments 38 and 40 are U-shaped track segments that provide returns between front track segments and back track segments, allowing traffic to move around the track 14 without traversing interior chord segments within sample handler or analyzer modules. This allows the track 14 to form an outer loop, with main traffic moving along the perimeter of the analyzer modules. Meanwhile, the internal track sections bypass the main loop, providing a direct path between two sides of each analyzer module (front to back), which serves as a route for local traffic. These chord segments can also be referred to as internal segments/track sections, bypass segments/track sections, or, in some cases, local track sections. These chord segments bypass the outer loop to provide access to a pipette. This allows small physical queues relevant to each sample handler or analyzer module to utilize those interior chord segments, without blocking the overall flow of track 14.

A specialized track segment module 36 facilitates sample return and branching within track 14 to allow the central computer system of the PCM to direct traffic in flexible ways. The outside track portions provide a way for samples to move from sample handler modules 10 to track segments of analyzer module 32, and vice versa. Meanwhile, the inner chord of track segment module 36 provides a branch whereby samples can move from analyzer 32 to analyzer 34 (in a counterclockwise manner), without moving into sample handler modules 10. This facilitates multiple tests on a single sample tube, allowing sample tubes to freely move between analyzer modules, regardless of how they are arranged on the right-hand side of system 30. This gives the PCM scheduling software flexibility in how samples order the tests within analyzer modules, without increasing traffic on the track segments relating to sample handling. Track segment 36 provides a boundary between sources and sinks (e.g., sample handler modules 10) and processors (e.g., analyzer modules 32 and 34) by providing a branching loop within section 36 (and section 42, in some embodiments). This loop allows sample carriers to move between the sources, sinks, and processors, including allowing samples to loop without returning to the sources and sinks.

Not shown in FIG. 3 is the central computer that includes a system instrument manager software component. The instrument manager software consolidates information from lower-level modules, such as sample handler 10 and analyzer modules 32 and 34, to present this information to an operator. The instrument manager receives information from the other modules via a network within the system (e.g., an internal Ethernet network). Information may be requested and provided asynchronously between the modules and central computer. The central computer can also work between the LIS and vessel mover systems to schedule samples and their movement within the system. The central computer can also work between the vessel mover systems and individual modules to handoff control of the samples and to initiate testing of samples once they arrive at a location.

Additional information regarding in vitro diagnostics systems can be found in U.S. patent application Ser. No. 16/319,306, published as U.S. Patent Application Pub. No. 2019/0277869A1, titled AUTOMATED CLINICAL ANALYZER SYSTEM AND METHOD, filed Jan. 18, 2019, which is hereby incorporated by reference herein in its entirety.

### PCB-Based Automation Track Configurations

Various liquid handlers can include a variety of different transport systems, including magnetic drive systems, friction-based track systems, or conveyor belts. For example, some liquid handlers include a track having a plurality of synchronously controlled magnetic coils. In these analyzer systems, the automation track is configured to move the sample carriers via synchronously controlled magnetic coils that propel the sample carriers along the analyzer system's track sections. However, conventional magnetically driven transport systems use metallic substrates for the automation track. Metallic substrates have several disadvantages, including cost and weight, as generally discussed above. Accordingly, embodiments of transport systems described herein include PCB-based substrates for the automation track. In these embodiments, each track segment can include one or more PCBs and coil arrays that are configured to electromagnetically actuate the vessel mover to transport the vessel mover therealong.

In some embodiments, track sections are divided up into a number of coil boards. A coil board includes a linear array of coils that can be mounted the PCB substrate of the track. For straight sections of track, each coil board is straight, while, in corners or curves, coil boards include appropriately laid out coils to match the curve. All coil boards are controlled by master boards and node controllers. In some embodiments, each master board can control up to eight different coil boards. Meanwhile, a node controller is centralized. A single node controller can control the entire vessel mover track. In some embodiments, multiple distributed node controllers can be used for expandability. For example, in larger systems, where the track extends for several meters, multiple node controllers may be used, and control of carriers can be handed off as they traverse different regions of the track network.

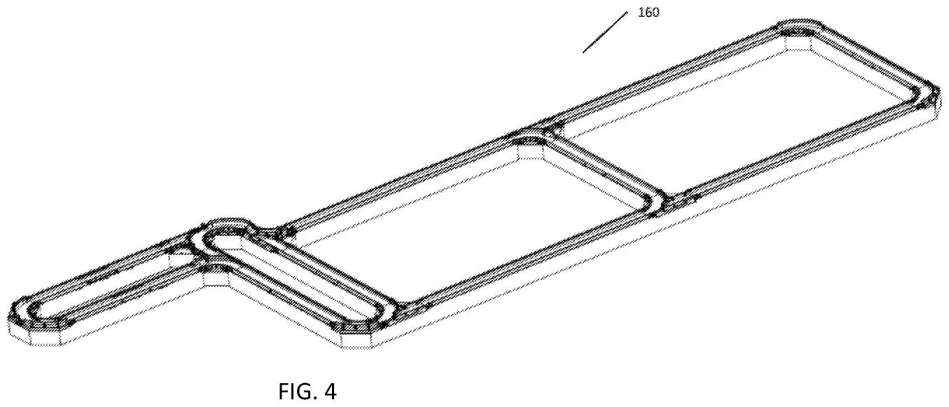

FIG. 4 shows a perspective view of track system 160. Track system 160 is configured to have a single sample handler unit and two analyzer modules. FIG. 5 shows track system 160 situated in a fully operational analyzer system 162 that includes a sample handler module 10 and two analyzer modules of 32 and 34. As can be seen, track system 160 is housed within the modules themselves, such that the track is not easily accessible to an operator. However, track 160 and analyzer system 162 utilize a modular design whereby track components reside within each module and each module can easily be linked together to join the track segments by placing adjacent modules in proximity and linking them. Lids above track 160 can be removed during installation or service to facilitate linking of tracks. In some embodiments, track sections and expanded by placing modules adjacent to one another and bolting the track sections of each module together forming a single multi-branching track system, such as track 160. Signaling cables can be daisy-chained together for ease of expanding control.

FIG. 6 shows a cross-sectional view of the track section 170. Track section 170 may be track section used in track 160. In this embodiment, carriers ride between rails 172 on a track surface 174. In some embodiments, rails 172 are aluminum extrusions that also include vertical sides on the exterior of the track components underneath track surface 174. These aluminum extrusions can include brackets to easily bolt internal components to these side pieces to form a track unit. In the embodiments described herein, the track surface 174 is a PCB. In various embodiments, the PCB track surface 174 can include one or more coatings or other components. At the bottom of the side components of rails 172 resides a baseplate 176. Baseplate 176 can be mounted to the modules containing track section 170 and provide support for the track system.

Beneath track surface 174 reside a series of coils 180. The longitudinal direction of track section 170 is into the page; as you travel along the track section 170, you encounter additional coils 180. Coils 180 are preferably mounted to coil boards 182 and are preferably laterally oblong to allow more coil density in the longitudinal direction of the track. In some embodiments, coil boards 182 are printed circuit boards (PCB) that include several coils 180 in the longitudinal direction. An exemplary coil board is 250 mm in length, accommodating all of the coils 180 needed for 250 mm of track. Thus, a typical track section will have several coil boards 182, including dozens of coil boards 182 to make up an entire track system. In some embodiments, coil boards 182 receive a control signal to indicate the trajectory to apply to a carrier traveling along that coil board and a power source of 24 VDC. Coil boards 182 include coils 180, motor drivers to drive those coils, and one or more sensors to detect the presence of carriers traversing the track surface above the coil board by detecting the magnets of the carrier. These sensors can include Hall Effect sensors to detect the presence and location of the carrier traveling along the coil board. Accordingly, there may be more sensors than coils, allowing fine resolution of the position of a carrier traversing track surface 174. Furthermore, an RFID receiver may be utilized to receive an RFID signal that identifies the carrier traveling along the track surface. In some embodiments, magnetic signatures unique to each carrier can be detected by the Hall Effect sensors to determine the identity of the carrier magnetically. For example, a carrier traversing an array of Hall Effect sensors can be characterized at manufacturing to identify a unique signature of that carrier based on rise times and signal artifacts that are detected by the Hall Effect or sensor array as magnets in the carrier travel over that array. In some embodiments, smaller magnets than the main drive magnets may be placed in the bottom portion of a carrier to intentionally create a unique signature for each carrier at manufacturing. This magnetic signature can be correlated to an identity of each carrier in software for the vessel mover system. An exemplary linear synchronous motor drive system is described in U.S. Pat. No. 9,346,371.

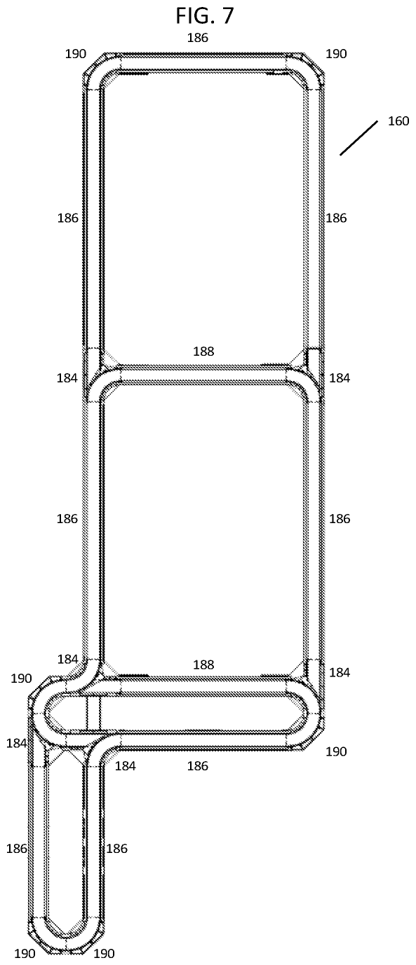

FIG. 7 shows a top view of an exemplary track system 160 with the individual track sections identified. There are generally four types of track sections that make up the modular design of track system 160. Switching segments 184 are branches in the track. The track surface for switching segments 184 is generally T-shaped, with rounded inside edges. Meanwhile, the rails of switching segments 184 include one straight rail (top of the T), one radiused rail (one inside corner of the T), and one radiused rail that includes a switching mechanism (other inside corner of the T). This switching mechanism is a movable rail component that can be turned a predetermined number of degrees to act as a switch (e.g., 20-30 degrees, depending on geometry). On one side of the rail component, it acts as a straight rail. On the other side of the rail component, the rail presents itself as a radiused rail forming an outside corner of a turn. By switching a movable rail component, that movable rail component can either provide the outside of a turn, or a simple straightaway rail. Thus, the mobile component provides a binary switch whereby switching segment 184 presents itself as a turn or as a straightaway, depending on the control signal. This can be used to divert individual carriers based on the state of the switching segment. It should be noted that, while the track may be bidirectional, only one end of the T can be connected to the center portion of the T to form a turn. Thus, while switching segments 184 may have three ports, essentially, one port may be switched to either of the other two ports, but those two ports cannot be joined together.

A simpler type of track section is a straightaway, such as outside straightaway 186 or inside straightaway 188. The basic components of straightaways 186 and 188 are a track surface and rails, with a series of coil boards providing linear motive forces along the direction of that straightaway. Straightaways 186 and 188 are identified separately in FIG. 7 because inside straightaways 188 can be operated under the control of the local module, rather than a vessel mover controller that controls the entire track 160, in some embodiments. This allows each local module to independently operate track sections 188 to act as a local random-access queue. The vessel mover controller can hand off control to the local module after moving a carrier from a switching segment 184 to the local inside straightaway 188. Similarly, when a local module has completed aspirations on a sample residing on inside straightaway 188, that module may move the sample carrier into a switching segment 184 and hand off control to the vessel mover controller. In some embodiments, inside track sections 188 still operate under the control of the vessel mover controller that controls the entire track system 160. To control a local queue on inside straightaway 188, the local module can communicate directly with the vessel mover controller to request movement of carriers within track section 188. This allows the local module to manifest control over carriers in its queue by using a request to acknowledge the communication system, allowing the vessel mover controller to have expertise in moving individual carriers and operating track system 160.

A fourth type of track segment is a curved track segment 190. Curved track segment 190 provides a 90° bend with a predetermined radius (or other angular bend). This radius is preferably the same as the radius used in turns when switching track segments 184 are switched into a curve. The radius is chosen to minimize the space impact of curves while, at the same time, allowing carriers to move quickly around curves without encountering drastic lateral forces. Thus, the space requirements and speed requirements of automation track 160 can determine the radius of curved segments 190.

Electrically, curved segments 190 are substantially the same as straightaways 186 and 188. Each of these segments includes a plurality of coils that are activated, in sequence, to provide a linear motor in conjunction with magnets in the bottoms of carriers. Each coil is activated to provide a push or pull force on drive magnets placed in the bottom of each carrier. The speed at which coils are activated in sequence determines the speed of the carrier on that section of track. Furthermore, carriers may be moved into a position and stopped at a predetermined location with high resolution by activating coils at that location.

Additional information regarding transport systems for liquid handlers can be found in U.S. patent application Ser. No. 16/319,306, which is incorporated by reference above.

### Automation Track Configurations for Mitigating Liquid Contaminants

As described above, automated analyzer systems can include automation tracks configured to move samples between different modules or components of the systems. These samples often include liquids. One issue that can arise in the context of transporting liquid-containing vessels is that it is relatively common for liquids to spill onto or otherwise contaminate the track system. As noted above, conventional automated analyzer systems utilize magnetically driven puck transport systems or conveyor belts. These conventional sample transport systems move the sample movers with sufficient inertia such that the vessel movers are not substantially impacted by the presence of liquid contaminants. However, as described above, the automated analyzer systems described herein utilize a PCB-based sample transport systems, which is inherently lighter and generates less thrust in transporting the vessel movers than the conventional sample transport systems. Because the vessel movers are lighter and move with less thrust, they accordingly have less inertia and thus can be substantially impacted by the presence of liquid contaminants on the track system. Therefore, the embodiments of sample transport systems described herein face a new technical problem that was not present in conventional analyzer transport systems. The issues with contaminants and the tribological characteristics of the track system riding surfaces could be faced by other sample transport systems where the vessel movers slide or roll along the track system; however, the PCB-based track systems described herein are less robust to the track-contamination problem. Accordingly, the present disclosure is directed to a variety of different track configurations for automated analyzer systems that are configured to redirect liquid contaminants from the surface of the track system. Further, it would be beneficial for these track configurations to redirect liquid contaminants in a passive manner so that they do not require any active control systems that can draw additional power and require additional layers of control architecture to manage.

In some of the embodiments of the track systems discussed below, various surfaces are described in terms of their “surface energy” or “wettability” characteristics. The surface energy (also known as interfacial free energy) of a substrate affects the degree of wetting experienced by a liquid on the substrate. In particular, a lower surface energy material (e.g., a liquid contaminant) will cover or “wet” a higher energy surface (e.g., the riding surface 206 of a track segment 201). Accordingly, the higher the surface energy of a substrate is, the more the liquid will wet (i.e., spread across) the substrate. Therefore, liquids will tend to flow from a substrate having a low surface energy to a higher surface energy. Similarly, the wettability of a surface defines the degree to which a liquid spreads across the surface. In particular, a surface having low wettability means that a given liquid will spread to a small degree and, correspondingly, a surface having a high wettability means that a given liquid will spread to a larger degree. In sum, low wettability for a surface will generally correspond to a high surface energy and, conversely, a high wettability for a surface will generally correspond to a low surface energy. The surface energy and/or wettability of a substrate can depend on, for example, the material of the substrate, any coatings present on the substrate, surface roughness, or texture, and whether the substrate has been treated with any surface modification techniques.

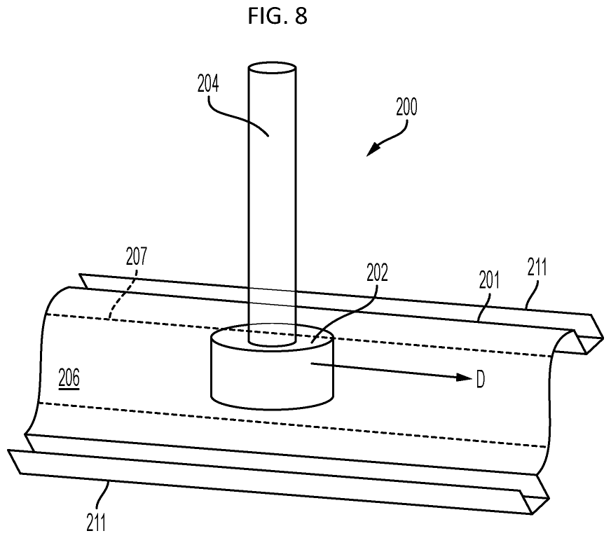

Various embodiments of track configurations that are configured to mitigate or prevent the negative effects of liquid contaminants on the riding surface 206 of the track system 200 are described below in connection with FIGS. 8-15. These embodiments are designed to effectuate multiple goals. First, some embodiments are configured to redirect liquid contaminants away from the medial portion of the riding surface 206 toward the lateral edges 210 thereof so that the liquid contaminants do not impact or inhibit the movement of the vessel movers 202 across the riding surface 206. Second, some embodiments are configured to reduce the wettability of the riding surface 206, which limits the amount that the liquid contaminant evaporates and dries while on the riding surface 206. In particular, a less wettable surface reduces the amount that a liquid spreads. Reducing the amount that a liquid spreads decreases the surface area, which in turn decreases the rate at which the liquid evaporates. Decreasing the rate at which liquid contaminants evaporate is beneficial because it mitigates the formation of dry films or crusts that are left on the riding surface 206 as liquid contaminants evaporate. Because such dry films or crusts could impact or impede the movement of the vessel movers 202, it is highly beneficial to avoid their formation. Partially dried films can in some cases be sticky and a result in significant undesirable adhesive interaction between the vessel mover and track surface. Accordingly, some embodiments of track systems described herein remove liquid contaminants from the riding surface 206 and, further, prevent the formation of byproducts on the riding surface 206. Further, these embodiments accomplish these goals in a passive manner, without requiring any additional electromechanical components or active control systems that would draw additional power and require additional layers of control architecture to manage.

FIG. 8 shows an illustrative embodiment of a track segment 201 of an automation track system 200, such as the track system 160 as shown in FIGS. 4-7. As generally described above, the automation track system 200 is configured to support one or more vessel movers 202, which are configured to receive a vessel 204 (also referred to as a “carrier” or “sample carrier”) therein. The track segment 201 can include a riding surface 206, which is the upper surface of the track segment 201 that supports the vessel mover 202 thereon and along which the vessel mover 202 is transported between the modules or components of the automation track system 200. In some embodiments, the riding surface 206 can include an active region 207 that the vessel mover 202 is intended to move along. As shown, the active region 207 is the area between the dashed lines. The active region 207 can generally correspond to the medial portion of the riding surface 206. If any liquid contaminants are present on the active region 207, they could negatively impact or otherwise impair the movement of the vessel movers 202, as noted above. In some embodiments, the track segment 201 could include a PCB substrate, as generally described above.

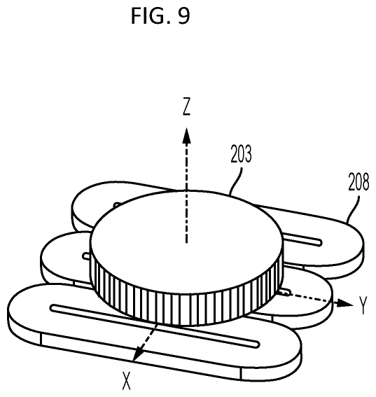

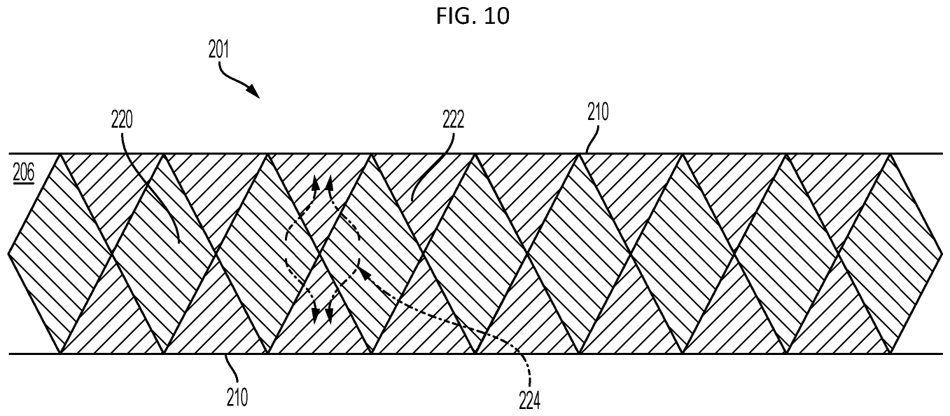

Further, as shown in FIG. 9, the track system 200 can include one or more coil arrays 208 associated with each track segment 201. The coil arrays 208 can be configured to generate a magnetic field that interacts with the magnet 203 positioned within the base of the vessel movers 202. The coil arrays 208 and the vessel mover magnet 203 can collectively define a linear electromechanical actuator. By synchronously controlling the coil arrays 208, the track system 200 can propel the vessel movers 202 (and, thus, the vessels 204 containing any samples or other liquids held thereby) across the track segments 201 to the desired module or other component of the liquid handler system.

FIG. 10 shows another illustrative embodiment of a track segment 201 of an automation track system 200. In this embodiment, the automation track system 200 includes a patterned surface configured to direct liquid contaminants away from the riding surface 206. In this embodiment, the riding surface 206 of the automation track system 200 includes low surface energy regions 220 and higher surface energy regions 222 that are arranged in a patterned configuration. The low surface energy regions 220 could include, for example, a hydrophobic coating. The higher surface energy regions 222 could include, for example, a low wettability coating.

The low surface energy regions 220 and the higher surface energy regions 222 can be arranged such that they define a surface energy gradient on the riding surface 206 that causes liquid contaminants to flow towards the lateral edges of the riding surface 206, i.e., from a medial portion of the riding surface 206 to a lateral portion thereof. In other words, the low surface energy regions 220 and the high surface energy regions 222 can be arranged such that as liquid flows from the low surface energy region 220 to the high surface energy region 222 (because, as noted above, liquids tend to flow from low to high surface energy), the liquid is directed to the lateral edges 210 of the riding surface 206. Accordingly, the arrangement of the regions 220, 222 causes any liquid contaminants present on the riding surface 206 to be passively directed away from the medial portion (i.e., active region 207) of the riding surface 206 to the lateral edges 210 thereof. In the illustrated embodiment, the low energy regions 220 are depicted as a series of diamond-shaped sections and the high energy regions 222 are depicted as a series of triangularly shaped sections interposed between the diamond-shaped low energy regions 220 along the lateral edges 210. However, the particular shapes and arrangement of the regions 220, 222 are simply provided for illustrative purposes. Alternative embodiments of track segments 201 could include regions 220, 222 that are shaped differently, are positioned different with respect to each other, and so on. Accordingly, alternative embodiments of the track segment 201 could include any number of regions 220, 222 having differing surface energies that collectively form a surface energy gradient on the riding surface 206. Further, the track segment 201 is not limited solely to having a low surface energy region 220 and a high surface energy region 222. Rather, alternative embodiments of the track segment 201 could have more than two regions with varying surface energies. Further, although the embodiment shown in FIG. 10 depicts that the regions 220, 222 are arranged in a regular or repeating pattern, alternative embodiments of the track segment 201 could have non-repeating arrangements of the regions 220, 222. In sum, the track segments 201 described herein could include any embodiments having a surface energy gradient that is configured to direct liquids from a medial portion of the riding surface 206 to the lateral edges 210 thereof.

In various embodiments, the lateral edges 210 can include troughs 211 for the collection and temporary storage of the removed liquid contaminants. Once removed from the riding surface 206 of the track segment 201, the liquid contaminants could then be collected from the lateral edges 210 and removed from the track system 200.

In various embodiments, the low surface energy region 220 could comprise a hydrophobic material, such as polytetrafluoroethylene (PTFE), fluorinated diamond-like carbon (DLC), or DLC with a perfluoropolyether (PFPE) coating. These materials could be applied as a coating to the riding surface 206 or be integral thereto. In various embodiments, the high surface energy region 222 could comprise uncoated, PCB substrate of the riding surface 206, other bare (i.e. uncoated) substrates (e.g., ceramic or stainless steel), or coated substrates having lower hydrophobicity relative to the lower surface energy region.

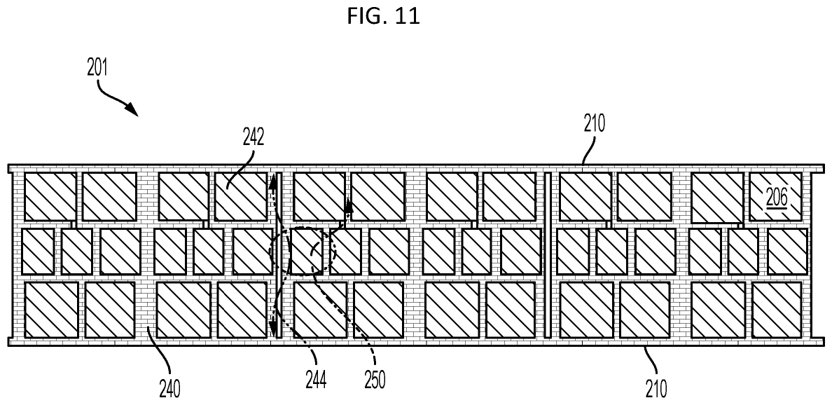

FIG. 11 shows another illustrative embodiment of a track segment 201 of an automation track system 200. In this embodiment, the automation track system 200 includes another patterned surface configured to direct liquid contaminants away from the riding surface 206, which differs from the patterned surface shown in the embodiment shown in FIG. 10. In this embodiment, the riding surface 206 of the automation track system 200 includes high surface energy regions 240 and low surface energy regions 242 that are arranged such that the high surface energy regions 240 define a series of pathways that are arranged to direct liquid contaminants 250 from the medial portion of the riding surface 206 to the lateral edges 210. The high surface energy regions 240 can include the uncoated, PCB substrate of the riding surface 206. The low surface energy regions 242 can include a hydrophobic material, such as PTFE, fluorinated DLC, or DLC with a PFPE coating.

In the illustrated embodiment, the high surface energy regions 240 effectively divide the low surface energy regions 242 into a series of “islands.” Because, as noted above, liquids tend to flow from a low surface energy substrate to a high surface energy substrate, any liquid contaminants present on the low surface energy regions 242 would tend to flow towards the high surface energy regions 240. Further, the arrangement of the pathways defined by the high surface energy regions 240 would then cause any liquid contaminants 250 to flow therealong to the lateral edges 210, as indicated by the directional arrow 244. Further, the track segment 201 is not limited solely to having a low surface energy region 220 and a high surface energy region 222. Rather, alternative embodiments of the track segment 201 could have more than two regions with varying surface energies. Further, although the embodiment shown in FIG. 10 depicts that the regions 240, 242 are arranged in a regular or repeating pattern, alternative embodiments of the track segment 201 could have non-repeating arrangements of the regions 240, 242. In sum, the high surface energy regions 240 and the low surface energy regions 242 collectively define a surface energy gradient on the riding surface 206 that causes liquid contaminants to flow towards the lateral edges 210 of the riding surface 206, i.e., from a medial portion of the riding surface 206 to a lateral portion thereof.

As with the embodiment shown in FIG. 10, the lateral edges 210 can include troughs 211 for the collection and temporary storage of the removed liquid contaminants. Once removed from the riding surface 206 of the track segment 201, the liquid contaminants could then be collected from the lateral edges 210 and removed from the track system 200. In one embodiment, the lateral edges 210 also could also be incorporated with pumping mechanisms to extract the collected contaminants for suitable disposal.

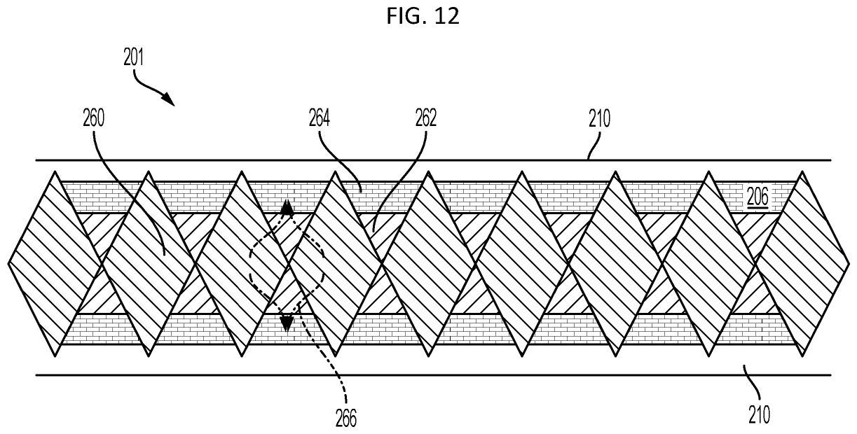

FIG. 12 shows another illustrative embodiment of a track segment 201 of an automation track system 200. In this embodiment, the automation track system 200 includes another patterned surface configured to direct liquid contaminants away from the riding surface 206, which differs from the patterned surface shown in the embodiments shown in FIGS. 10 and 11. In this embodiment, the riding surface 206 of the automation track system 200 includes low surface energy regions 260, medium surface energy regions 262, and high surface energy regions 264 that are arranged to direct liquid contaminants from the medial portion of the riding surface 206 to the lateral edges 210. The low surface energy regions 260 could include a hydrophobic material, such as PTFE, fluorinated DLC, or DLC with a PFPE coating. The medium surface energy regions 262 could include a hydrophilic coating, such as silicon-doped DLC. In one embodiment, the high surface energy regions 264 could include the uncoated, PCB substrate of the riding surface 206. In various embodiments, the high surface energy regions 264 may include bare substrate (e.g., PCB, ceramic, or metal) or could have a coating that is more hydrophilic than the medium surface energy regions 262.

In the illustrated embodiment, the low energy regions 260 are depicted as a series of diamond-shaped sections, medium surface energy regions 262 are depicted as a series of triangularly shaped sections interposed between the diamond-shaped low energy regions 260, and the low energy regions 264 are depicted as a series of trapezoidal-shaped sections. However, the particular shapes and arrangement of the regions 260, 262, 264 are simply provided for illustrative purposes. Alternative embodiments of track segments 201 could include regions 260, 262, 264 that are shaped differently, are positioned different with respect to each other, and so on. Further, although the embodiment shown in FIG. 11 depicts that the regions 260, 262, 264 are arranged in a regular or repeating pattern, alternative embodiments of the track segment 201 could have non-repeating arrangements of the regions 260, 262, 264. In sum, the high surface energy regions 260, medium surface energy regions 262, and low surface energy regions 264 collectively define a surface energy gradient on the riding surface 206 that causes liquid contaminants to flow towards the lateral edges 210 of the riding surface 206, i.e., from a medial portion of the riding surface 206 to a lateral portion thereof.

As with the embodiments shown in FIGS. 10 and 11, the lateral edges 210 can include troughs 211 for the collection and temporary storage of the removed liquid contaminants. Once removed from the riding surface 206 of the track segment 201, the liquid contaminants could then be collected from the lateral edges 210 and removed from the track system 200.

In the embodiments shown in FIGS. 10-12, the specific geometries (e.g., size and shape) of the patterning defined by the various regions can adjusted based on the specificity properties (e.g., the surface energy, hydrophobicity, and/or wettability) of the regions, the desired rate of removal of the liquid contaminants (which could, at least in part, be driven by the evaporation rate of the liquids), the dimensions (e.g., width) of the track segment 201, the typical size ranges of the blobs, drops, or films caused by the liquid contaminants, the ranges of the properties of the liquid contaminants (e.g., viscosity, density, and enthalpy of evaporation). Likewise, the coating material(s) used in the various regions could likewise be adjusted in different embodiments to control these factors.

The various coatings and/or materials described above with respect to the embodiments shown in FIGS. 10-12 can be fabricated using a variety of different techniques, including vapor deposition, brushing, dip-coating, and spin-coating. The particular technique selected to deposit and/or fabricate the materials with the track segment 201 could depend on the type of coating being applied, the thickness of the coating, tribological considerations, and the degree of compatibility of the coating material or process with the substrate material (e.g., PCB).

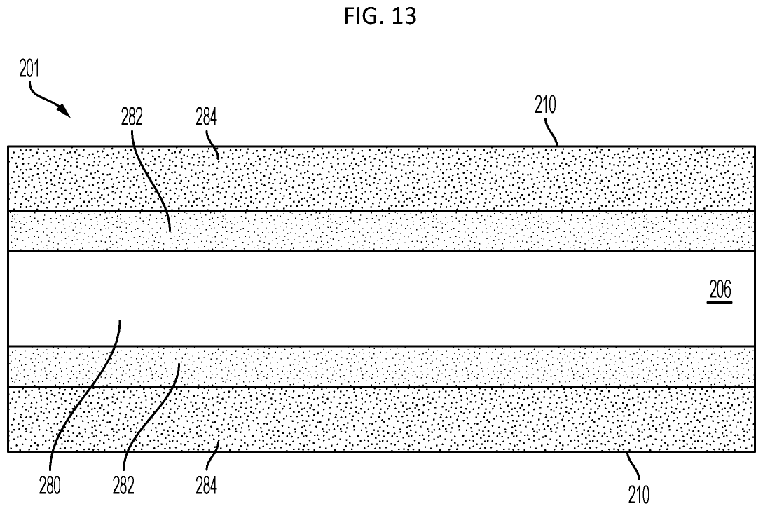

FIG. 13 shows a diagram of another illustrative embodiment of a track segment 201 of an automation track system 200. It has been found that rougher surfaces typically exhibit increased levels of wettability or surface energy by liquids due to the increased total effective surface area of the rougher surfaces. Accordingly, in some embodiments, the riding surface 206 of the track segment 201 can include a roughness gradient topography having increasing levels or bands of surface roughness from the medial portion towards the lateral edges 210 of the riding surface 206. In the illustrated embodiment, the riding surface 206 includes a first region 280 corresponding to a medial portion of the riding surface 206, second regions 282 corresponding to a medial-lateral portion of the riding surface 206, and third regions 284 corresponding to a lateral portion of the riding surface 206. In one embodiment, the first region 280 could correspond to the active region 207 of the riding surface 206. Although this embodiment is depicted as having three types of regions, this is simply for illustrative purposes. Alternative embodiments of track segments 201 could include any number of regions having differing roughness amounts that collectively form a roughness gradient topography on the riding surface 206. In sum, the track segments 201 described herein could include any embodiments having a surface roughness gradient where the riding surface 206 gets rougher from a medial portion of the riding surface 206 to the lateral edges 210 thereof.

The different roughness levels in the various regions 280, 282, 284 of the riding surface 206 can be created using a variety of different techniques. In some embodiments where the substrate of the riding surface 206 comprises glass, the varying amounts of roughness can be fabricated using controlled plasma treatment or controlled exposure to acidic or basic solutions with appropriate masking based on the desired surface roughness configuration. In some embodiments where the substrate of the riding surface 206 comprises PTFE, the varying amounts of roughness can be fabricated using wet etching or plasma treatment.

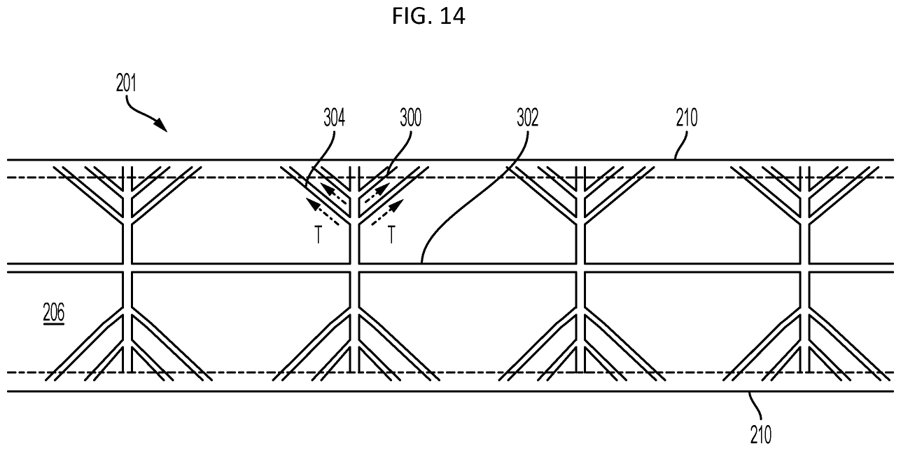

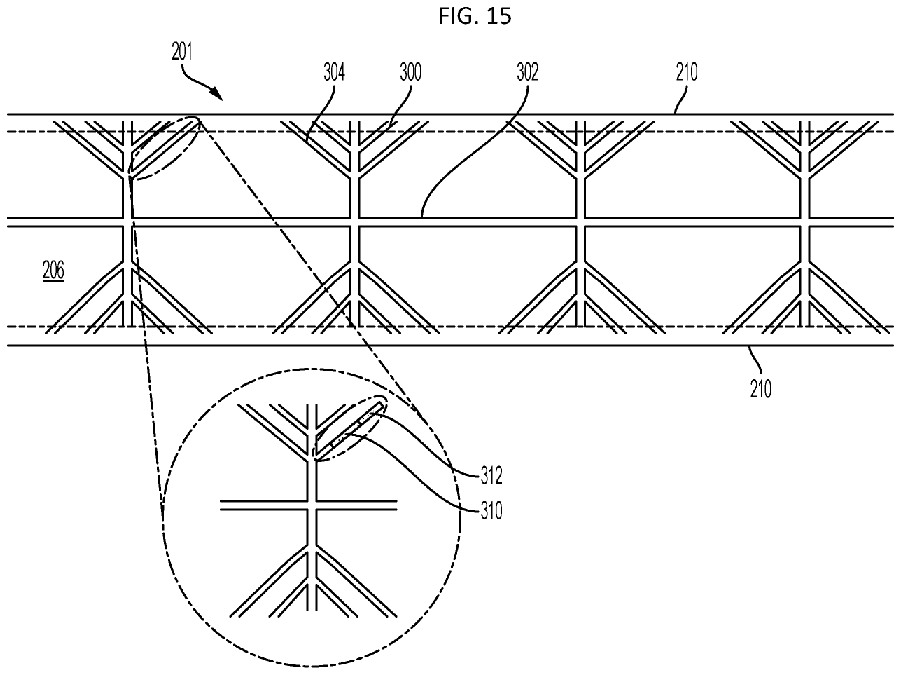

FIG. 14 shows a diagram of another illustrative embodiment of a track segment 201 of an automation track system 200. In this embodiment, the riding surface 206 includes one or more channels 300 that are configured to direct a liquid contaminant from a medial portion of the riding surface 206 to the lateral edges 210 thereof. In one embodiment, the channels 300 can include a longitudinal channel 302 extending longitudinally along a medial portion of the riding surface 206 and a plurality of lateral channels 304 extending from the longitudinal channel 302 to the lateral edges 210 of the riding surface 201. The longitudinal channel 302 and the lateral channels 304 are in fluid communication such that any liquid is able to flow therebetween.

In some embodiments, the channels 300 can be sized, shaped, or otherwise dimensioned to induce the movement of any liquids therein through capillary action. For example, the channels 300 can have a width on a size scale from tens of microns to a few mm, depending on the number of lateral micro-channel branches, the substrate material of the riding surface 206, and other factors. Accordingly, the longitudinal channel 304 could be configured to suck in any liquid contaminants on the medial portion of the riding surface 206 through capillary action, thereby removing the liquid contaminants from the active region 207 of the riding surface 206. Once in the longitudinal channel 304, the liquid contaminant would then be directed via capillary action through the lateral channels 304 to the lateral edges 210, removing the liquid contaminant from the riding surface 206. In order to create a capillary pressure gradient directed from the medial portion (i.e., the active region 207) of the riding surface 206 to the lateral edges 210, the width and/or depth of the channels 300 could be tapered towards the lateral edges 210. In other words, the width and/or depth of the channels 300 could decrease from the medial portion of the riding surface 206 to the lateral edges 210 thereof, which thereby generates a pressure gradient sufficient to induce capillary action of a liquid within the channels 300. The direction of the taper of the channels 300 is indicated by the arrows T in FIG. 14. As discussed above with respect to other embodiments, the lateral edges 210 can include troughs 211 for the collection and temporary storage of the removed liquid contaminants. Once removed from the riding surface 206 of the track segment 201, the liquid contaminants could then be collected from the lateral edges 210.

In some embodiments, the riding surface 206 could include features that are configured to direct liquids contaminants from the riding surface 206 into the channels 300. In one embodiment, the riding surface 206 could include a hydrophobic coating configured to direct any liquids on the riding surface 206 into one or more of the channels 300. In another embodiment, the riding surface 206 could include a surface energy gradient, similarly to the embodiments described above in connection with FIGS. 10-12, that is configured to direct liquids into one or more of the channels 300. In particular, the riding surface 206 could include high surface energy regions adjacent to the channels 300 and low surface energy regions positioned with respect thereto to cause liquids to flow to the high energy regions in order to direct liquids into the channels 300. In another embodiment, the riding surface 206 could include a surface roughness gradient, similarly to the embodiments described above in connection with FIG. 13, that is configured to direct liquids into one or more of the channels. In particular, the riding surface 206 could include high surface roughness regions adjacent to the channels 300 and low surface roughness regions positioned with respect thereto to cause liquids to flow to the high surface roughness regions in order to direct liquids into the channels 300.

In some embodiments, the channels 300 could be fabricated to be hydrophilic in order to induce liquid contaminants to be drawn into the channels 300. In these embodiments, the channels 300 could be hydrophilic in addition to or in lieu of being configured to induce capillary action in any liquids that come in contact therewith, as discussed above. The channels 300 could be made to be hydrophilic using a variety of different techniques. In one embodiment wherein the riding surface 206 comprises glass, the hydrophilicity of the channels 300 could be adjusted by, for example, treating the channels 300 with acidic or basic solutions or plasma treating the channels 300.

Although the embodiment in FIG. 14 is depicted as having a single longitudinal channel 302 and multiple lateral channels 304 arranged in a branching, tree-like configuration, this embodiment is simply for illustrative purposes. Other embodiments could include multiple longitudinal channels 302 and/or lateral channels 304 arranged in alternative configurations. In sum, the track segments 201 described herein could include any embodiments having one or more channels 300 that are configured to direct liquid contaminants from a medial portion of the riding surface 206 to the lateral edges 210 thereof through capillary action. In addition, the channels 300 could be of different widths to accommodate the desired transport of a variety of contaminant fluids (e.g., blood or horse serum), which can differ in viscosity and surface tension values.

The channels 300 could be created in the riding surface 206 using a variety of different techniques. In some embodiments, the channels 300 could be etched or machined on the riding surface 206. In one embodiment where the riding surface 206 comprises a layer of PTFE (e.g., to reduce sliding friction of the vessel movers 202), the channels 300 could be etched in the PTFE later. Further, the channels 300 could then undergo a plasma treatment or a wet etching process to increase their hydrophilicity, as discussed above.

In one embodiment, the coil arrays 208 could further be configured to induce a temperature gradient extending medially towards the lateral edges 210 of the riding surface 206. Due to thermo-capillary effects, the temperature gradient could enhance the capillary pressure gradient and, accordingly, increase the induced flow of liquid through the channels 300 to the lateral edges 210 of the riding surface. In particular, surface tension reduces with increasing temp. Accordingly, in one embodiment, the heat generated by the activated coil arrays 208 due to Ohmic heating could be distributed by manipulating the heat sinking and heat capacity of the substrate locally. By maintaining a temperature gradient laterally across the width of the track surface with temperature reducing from the centerline towards the edges of the track, the surface energy gradient created by the channels 300 and/or coatings described herein could be further amplified to drive a stronger transport of the contamination away from the active zone of the riding surface 206 towards the lateral edges 210.

FIG. 15 shows a diagram of another illustrative embodiment of a track segment 201 of an automation track system 200, which is similar in many respects to the embodiment shown in FIG. 14. In this embodiment, one or more of the channels 300 further includes a gradient that is configured to further induce flow of liquids through the channels 300 from a medial portion of the riding surface 206 to the lateral edges 210 thereof. In one illustrative embodiment, the one or more of the channels 300 could include a first region 310 having a low surface energy or surface roughness and a second region 312 having a higher surface energy or surface roughness. Similarly, as discussed with respect to the embodiments above, liquids are generally induced to flow from a low to a higher surface energy or surface roughness. Accordingly, by using these same concepts within the channels 300 themselves, these same concepts could be used to induce the flow of liquid therethrough. These surface gradients within the channels 300 could be used in addition to or in lieu of the channels 300 being configured to induce capillary action, as discussed above with respect to the embodiment shown in FIG. 14.

The same techniques discussed above for controlling or fabricating the surface energy gradients and/or surface roughness gradients could likewise be applied to the embodiment shown in FIG. 15. Although this embodiment is depicted as having two types of regions 310, 312, this is simply for illustrative purposes. Alternative embodiments of track segments 201 could include channels 300 having any number of regions having differing amounts of roughness and/or surface energies that collectively form a gradient topography within the channels 300. In sum, the track segments 201 described herein could include any embodiments including channels 300 having surface energy gradients and/or surface roughness gradients that are configured to cause liquid to flow from a medial portion of the riding surface 206 through the channels 300 to the lateral edges 210 thereof.

In sum, the present disclosure describes a variety of different configuration of track systems 200 and/or track segments 201 thereof that are configured to passively remove liquid contaminants from the riding surface 206 and thereby mitigate the effects of any liquid contaminants on the vessel movers 202. Further, any of the embodiments of the track segments 201 described above could be combined with any other described embodiments. For example, the features of the embodiment shown in FIG. 10 could be combined with the features shown in FIG. 14. Any other combination of two or more of the described embodiments is within the scope of the present disclosure.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

A second action can be said to be “in response to” a first action independent of whether the second action results directly or indirectly from the first action. The second action can occur at a substantially later time than the first action and still be in response to the first action. Similarly, the second action can be said to be in response to the first action even if intervening actions take place between the first action and the second action, and even if one or more of the intervening actions directly cause the second action to be performed. For example, a second action can be in response to a first action if the first action sets a flag and a third action later initiates the second action whenever the flag is set.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A track system for a liquid handler system, the track system configured to transport a vessel mover, the vessel mover comprising a magnet, the track system comprising:
a track segment comprising a substrate, the substrate comprising a surface configured to support the vessel mover thereon;
a coil array associated with the track segment, the coil array configured to interact with the magnet to define a linear electromagnetic actuator and propel the vessel mover along the track segment;
a first region on the surface, the first region comprising a first surface energy; and
a second region on the surface, the second region comprising a second surface energy;
wherein:
the first surface energy is less than the second surface energy,
the first region and the second region are non-overlapping, and
the first region and the second region define a surface energy gradient that is configured to cause a liquid on the surface to flow towards a lateral edge of the surface.

2. The track system of claim 1, wherein the first region comprises a hydrophobic coating and the second region comprises an uncoated surface of the PCB substrate.

3. The track system of claim 1, wherein the first region comprises a hydrophobic coating and the second region comprises a hydrophilic coating.

4. The track system of any one of claims 1-3, wherein the substrate comprises a printed circuit board (PCB) substrate.

5. The track system of any one of claims 1-4, further comprising:
a third region on the surface, the third region comprising a third surface energy;
wherein:
the third surface energy is less than the second surface energy and more than the first surface energy,
the third region does not overlap with the first region or the second region, and
the first region, the second region, and the third region define the surface energy gradient that is configured to cause a liquid on the surface to flow towards a lateral edge of the surface.

6. The track system of any one of claims 1-5, wherein the second region is arranged along the lateral edge of the surface.

7. The track system of any one of claims 1-6, wherein the second region defines a plurality of pathways extending through the first region, the plurality of pathways configured to direct the liquid to the lateral edge of the surface.

8. A liquid handler system for analyzing a sample contained with a vessel, the liquid handle system comprising:
a vessel mover configured to receive the vessel, the vessel mover comprising a magnet; and
a track system configured to transport the vessel mover, the track system comprising:
a track segment comprising a substrate, the substrate comprising a surface configured to support the vessel mover thereon,
a coil array associated with the track segment, the coil array configured to interact with the magnet to define a linear electromagnetic actuator and propel the vessel mover along the track segment,
a first region on the surface, the first region comprising a first surface energy, and
a second region on the surface, the second region comprising a second surface energy,
wherein:
the first surface energy is less than the second surface energy,
the first region and the second region are non-overlapping, and
the first region and the second region define a surface energy gradient that is configured to cause a liquid on the surface to flow towards a lateral edge of the surface.

9. The liquid handler system of claim 8, wherein the first region comprises a hydrophobic coating and the second region comprises an uncoated surface of the substrate.

10. The liquid handler system of claim 8, wherein the first region comprises a hydrophobic coating and the second region comprises a hydrophilic coating.

11. The liquid handler system of any one of claims 8-10, wherein the substrate comprises a printed circuit board (PCB) substrate.

12. The liquid handler system of any one of claims 8-11, wherein the track system further comprises:
a third region on the surface, the third region comprising a third surface energy;
wherein:
the third surface energy is less than the second surface energy and more than the first surface energy,
the third region does not overlap with the first region or the second region, and
the first region, the second region, and the third region define the surface energy gradient that is configured to cause a liquid on the surface to flow towards a lateral edge of the surface.

13. The track system of any one of claims 8-12, wherein the second region is arranged along the lateral edge of the surface.

14. A track system for a liquid handler system, the track system configured to transport a vessel mover, the vessel mover comprising a magnet, the track system comprising:
a track segment comprising a substrate, the substrate comprising a surface configured to support the vessel mover thereon;
a coil array associated with the track segment, the coil array configured to interact with the magnet to define a linear electromagnetic actuator and propel the vessel mover along the track segment;
a first region on the surface, the first region comprising a first roughness; and
a second region on the surface, the second region comprising a second roughness;
wherein:
the first roughness is less than the second roughness,
the first region and the second region are non-overlapping, and
the first region and the second region define a surface roughness gradient that is configured to cause a liquid on the surface to flow towards a lateral edge of the surface.

15. The track system of claim 14, wherein the second region is formed via a surface modification process selected from the group consisting of a plasma treatment, exposure to an acidic solution with masking, or exposure to a basic solution with masking.

16. The track system of claim 14 or claim 15, wherein the track system further comprises:
a third region on the surface, the third region comprising a third roughness;
wherein:
the third roughness is less than the second roughness and more than the first roughness,
the third region does not overlap with the first region or the second region, and
the first region, the second region, and the third region define the surface roughness gradient that is configured to cause a liquid on the surface to flow towards a lateral edge of the surface.

17. The track system of any one of claims 14-16, wherein the second region is arranged along the lateral edge of the surface.

18. The track system of any one of claims 14-17, wherein the substrate comprises a printed circuit board (PCB) substrate.

19. A track system for a liquid handler system, the track system configured to transport a vessel mover, the vessel mover comprising a magnet, the track system comprising:
a track segment comprising a substrate, the substrate comprising a surface configured to support the vessel mover thereon;
a coil array associated with the track segment, the coil array configured to interact with the magnet to define a linear electromagnetic actuator and propel the vessel mover along the track segment; and
a plurality of channels extending along the surface, the plurality of channels configured to cause a liquid on the surface to flow towards a lateral edge of the surface via capillary action.

20. The track system of claim 19, wherein one or more of the plurality of channels comprises at least one of a surface energy gradient or a surface roughness gradient induce the flow of the liquid therethrough.

21. The track system of claim 19 or claim 20, wherein a cross-section of the plurality of channels tapers from a centerline of the surface to the lateral edge.

22. The track system of any one of claims 19-21, further comprising a low surface energy coating disposed proximal to a centerline of the surface, wherein a portion of the plurality of channels comprises an increased hydrophobicity to define a surface energy gradient with the low surface energy coating.

23. The track system of any one of claims 19-22, wherein the substrate comprises a printed circuit board (PCB) substrate.
